(19) United States
(12) Patent Application Publication
(10) Pub. No.: US 2016/0161918 A1
(43) Pub. Date: Jun. 9, 2016

(54) MECHANICAL AND SMART WATCH COMBINATION

(71) Applicant: WILLIAM C. KNEEBUSCH, Valley City, OH (US)

(72) Inventor: WILLIAM C. KNEEBUSCH, Valley City, OH (US)

(21) Appl. No.: 14/950,716

(22) Filed: Nov. 24, 2015

Related U.S. Application Data
(60) Provisional application No. 62/087,484, filed on Dec. 4, 2014.

(51) Int. Cl. G04B 47/00; G04B 37/00; G04G 17/02

(52) U.S. Cl. CPC G04B 47/00; G04G 17/02; G04B 37/0083

(57) ABSTRACT

A watch including a top watch and a bottom watch, wherein the top watch and the bottom watch are movably connected to each other, is described herein.

This application claims priority to U.S. Ser. No. 62/087,484, filed Dec. 4, 2014, entitled Mechanical and Smart Watch Combination, the contents of which are incorporated by reference.

### I. BACKGROUND

A. Field

This invention generally relates to methods and apparatuses for watches, and more particularly, to attaching a watch with a smart watch.

B. Description of the Related Art

Currently, individuals must choose between wearing a mechanical watch or wearing a smart watch.

### II. SUMMARY

In one embodiment, a mechanical watch is physically connected to a smart watch.

In another embodiment, the mechanical watch is connected to the smart watch via a hinge.

The present teachings provide a way to utilize the utility of a smart watch and the appearance of a conventional watch. Other benefits and advantages will become apparent to those skilled in the art to which it pertains upon reading and understanding of the following detailed specification.

### III. DEFINITIONS

Digital watch—a watch that shows the time by means of displayed digits rather than hands or a pointer.

Mechanical watch—a watch that uses a mechanical mechanism to measure the passage of time.

Quartz watch—a watch a uses an electronic oscillator that is regulated by a quartz crystal to keep time.

Smart watch—a mobile device with a touchscreen display, designed to be worn on the wrist, or to operate as a pocket watch.

Watch—a small timepiece designed to be worn or carried.

### IV. BRIEF DESCRIPTION OF THE DRAWINGS

Example arrangements are described hereinafter with reference to the accompanying drawings.

FIG. 1 shows a side view of a mechanical watch connected on top of a smart watch;

FIG. 2 shows a top view of the mechanical watch connected to the smart watch;

FIG. 3 shows another side view of the mechanical watch connected to the smart watch;

FIG. 4 shows a perspective view of the mechanical watch being pivoted off of the smart watch;

FIG. 5A shows a perspective view of another embodiment;

FIG. 5B shows a bottom view of another embodiment;

FIG. 5C shows a top view of a watch face;

FIG. 6A shows a perspective view of another attachment embodiment; and,

FIG. 6B shows a perspective view of another attachment embodiment.

### V. DETAILED DESCRIPTION

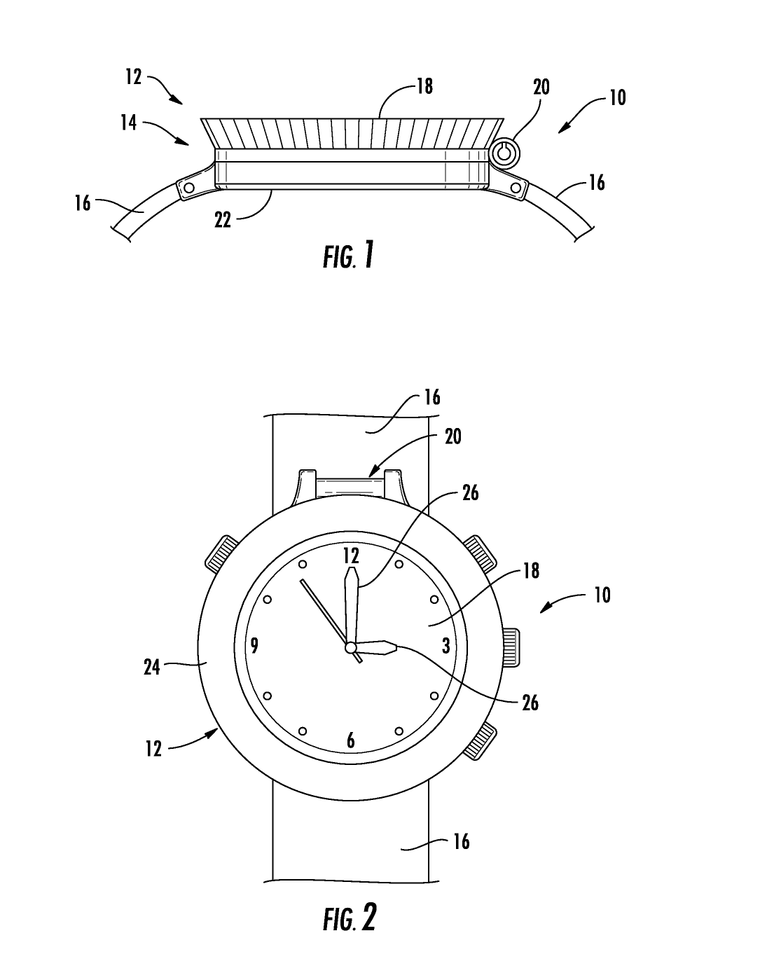

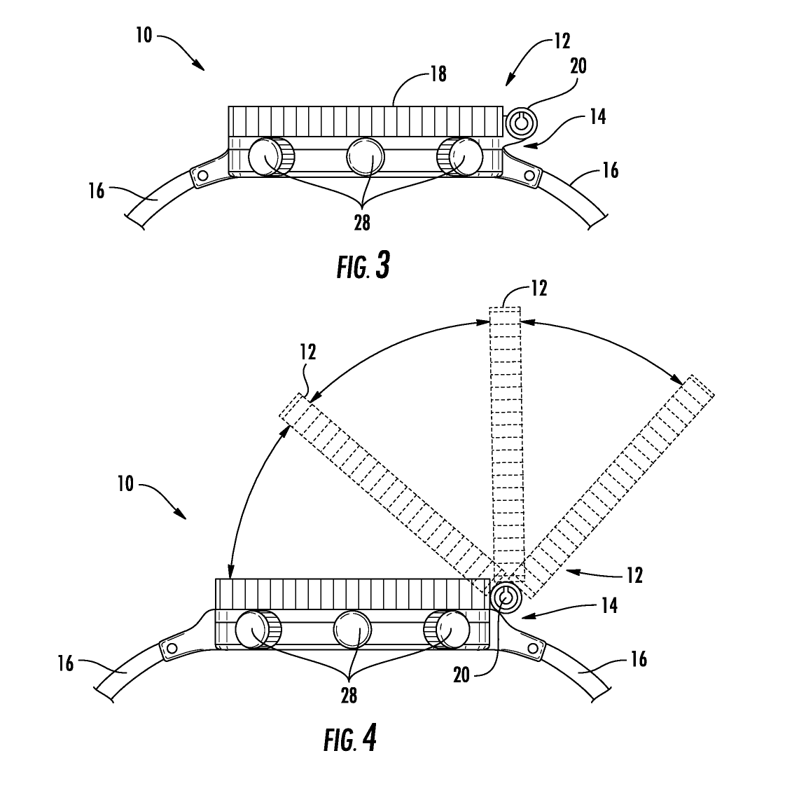

In reference to the FIGS. 1-6B, a wrist watch 10 is shown, wherein a mechanical watch 12 is connected to a smart watch 14, wherein the watch 10 has a band 16 and a back 22. The mechanical watch 12 has a face 10, a bezel 24, and hands 26 (although the mechanical watch 12 could be a digital watch as well). The smart watch 14 has a back 22 and control buttons 28. The connection between the mechanical watch 12 and the smart watch 14 can be accomplished with any means chosen sound engineering judgment. With respect to FIGS. 1-4, the connection between the mechanical watch 12 and the smart watch 14 is shown with an attachment 20 at the side of the two watches 12,14, wherein a pivotable attachment 20 connects the two watches 12,14. The watches 12,14 can be pivotably attached at any location of the two watches 12,14, such that the top watch 12 opens parallel to the band 16 or perpendicular to the band 16.

With continuing reference to FIGS. 1-4, the mechanical watch 12 is shown pivotably attached to the smart watch 14, such that the mechanical watch 12 pivotably moves away from the smart watch 14. However, it is to be understood that the two watches 12,14 could be attached in any manner that allows the mechanical watch 12 to be temporarily moved so that the smart watch 14 is accessible. Some non-limiting examples are pivots, clasps, sliding attachment, clips, hinges, rotational attachments, etc. As shown in FIG. 4, the top watch 12 rotates about the attachment 20, such that the top watch 12 swings away from the smart watch 14, revealing the smart watch 14 for use. Once the user is done utilizing the smart watch 14, the top watch 12 can be rotating back around the attachment 20, thereby covering the smart watch 14. When in the closed position, the top watch 12 either completely, or substantially completely, covers the smart watch 14, so that the face of the smart watch 14 cannot be seen. In FIGS. 1-4, the attachment 20 is shown along the latitudinal axis of the watch 10.

With continuing reference to FIGS. 1-6B, it also to be understood that any type of watch 12 may be connected to the top of the smart watch 14, including, but not limited to, another smart watch, a mechanical watch, a digital watch, or a quartz watch.

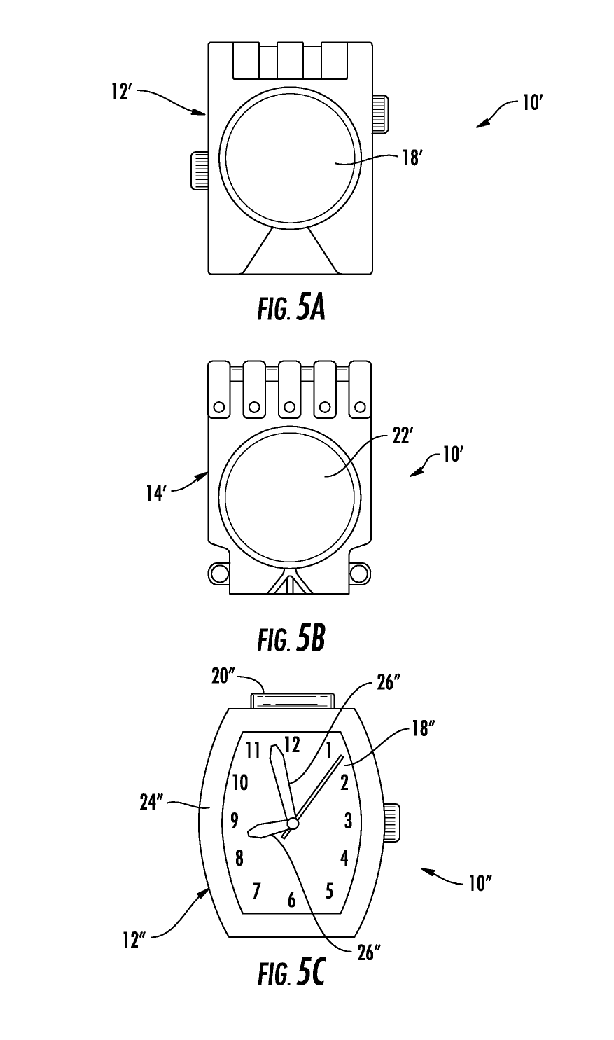

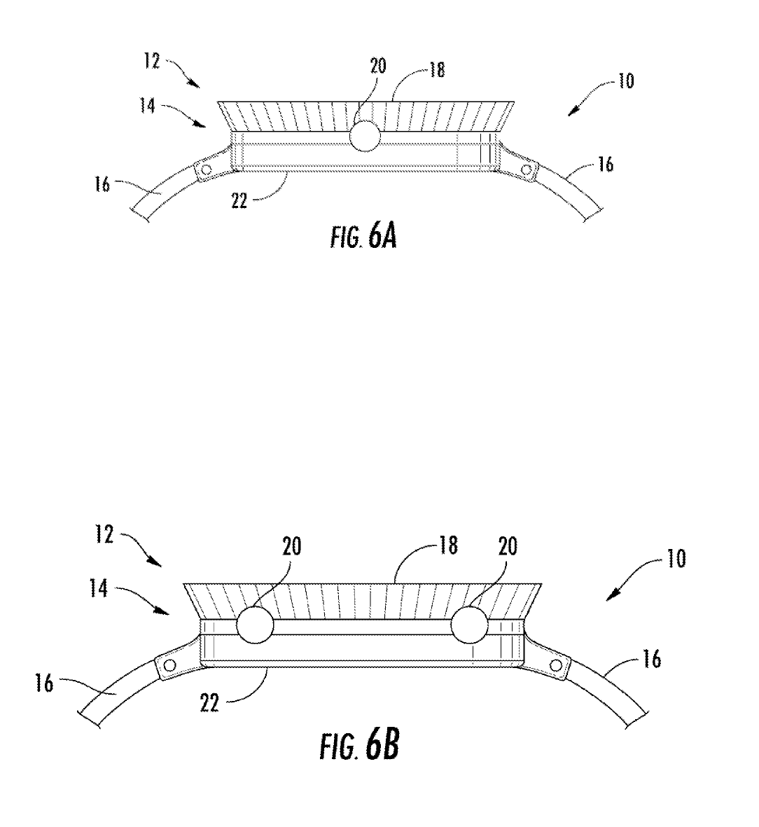

With reference to FIGS. 5A-5C, different embodiments of the watch 10′, 10″ are shown. The watch 10′ is square shaped, and is attached via a hinge 20′ at one end of the watch 10′. The mechanical watch 12′ has a face 18′, and the smart watch 14′ has a back 22′. FIG. 5C shows another embodiment of the watch 10″, wherein the mechanical watch 12″ has a bezel 24″, a face 18″, hands 26″, and an attachment hinge 20″ to connect the watch 12″ to the watch 14″. FIGS. 6A and 6B show the hinge 20 along the longitudinal axis of the watch 10.

Therefore, from one perspective, there has been described a watch combination. Further examples consistent with the present teachings are set out in the following numbered clauses.

Clause 1—A watch comprising a top watch and a bottom watch, wherein the top watch and the bottom watch are movably connected to each other.

Clause 2—The watch of clause 1, wherein the bottom watch is a smart watch and the top watch is not a smart watch.

Clause 3—The watch of clauses 1 or 2, wherein top watch is rotably connected to the bottom watch at a pivot point between the top watch and the bottom watch.

Clause 4—The watch of clauses 1-3, wherein the top watch is operatively connected to the bottom watch by one of the group consisting of pivots, clasps, sliding attachments, clips, hinges, and rotational attachments.

Clause 5—The watch of clauses 1-4, wherein the top watch is operatively connected to the bottom watch by a hinge.

Clause 6—The watch of clauses 1-5, wherein the watch further comprises a band, wherein the band is operatively connected to the bottom watch.

Clause 7—The watch of clauses 1-4 and 6, wherein the top watch is slidably engaged with the bottom watch.

Clause 8—The watch of clauses 1-6, wherein the top watch rotates away from the bottom watch from between about 90° and about 180°.

Clause 9—The watch of clauses 1-6 and 8, wherein the watch has a longitudinal axis and a latitudinal axis, wherein the top watch rotates away from the bottom watch along the longitudinal axis.

Clause 10—The watch of clauses 1-6 and 8, wherein the watch has a longitudinal axis and a latitudinal axis, wherein the top watch rotates away from the bottom watch along the latitudinal axis.

Clause 11—The watch of clauses 1-4, 6, and 7, wherein the top watch slides along the length of the bottom watch.

Clause 12—The watch of clauses 1-11, wherein the top watch substantially covers the bottom watch.

Clause 13—The watch of clauses 1-12, wherein the watch is a pocket watch.

Clause 14—The watch of clauses 1-13, wherein the top watch is selected from the group consisting of smart watch, a mechanical watch, a digital watch, and a quartz watch.

Clause 15—The watch of clauses 1-14, wherein the bottom watch is selected from the group consisting of smart watch, a mechanical watch, a digital watch, and a quartz watch.

Various example embodiments have been described above for a watch combination. Skilled readers will understand, however, that changes and modifications may be made without departing from the spirit and scope of the following claims and their equivalents.

I/We claim:

1. A watch comprising:
a top watch; and,
a bottom watch, wherein the top watch and the bottom watch are movably connected to each other.

2. The watch of claim 1, wherein the bottom watch is a smart watch and the top watch is not a smart watch.

3. The watch of claim 1, wherein top watch is rotably connected to the bottom watch at a pivot point between the top watch and the bottom watch.

4. The watch of claim 1, wherein the top watch is operatively connected to the bottom watch by one of the group consisting of pivots, clasps, sliding attachments, clips, hinges, and rotational attachments.

5. The watch of claim 4, wherein the top watch is operatively connected to the bottom watch by a hinge.

6. The watch of claim 4, wherein the watch further comprises a band, wherein the band is operatively connected to the bottom watch.

7. The watch of claim 4, wherein the top watch is slidably engaged with the bottom watch.

8. The watch of claim 6, wherein the top watch rotates away from the bottom watch from between about 90° and about 180°.

9. The watch of claim 8, wherein the watch has a longitudinal axis and a latitudinal axis, wherein the top watch rotates away from the bottom watch along the longitudinal axis.

10. The watch of claim 8, wherein the watch has a longitudinal axis and a latitudinal axis, wherein the top watch rotates away from the bottom watch along the latitudinal axis.

11. The watch of claim 7, wherein the top watch slides along the length of the bottom watch.

12. The watch of claim 1, wherein the top watch substantially covers the bottom watch.

13. The watch of claim 1, wherein the watch is a pocket watch.

14. The watch of claim 1, wherein the top watch is selected from the group consisting of smart watch, a mechanical watch, a digital watch, and a quartz watch.

15. The watch of claim 1, wherein the bottom watch is selected from the group consisting of smart watch, a mechanical watch, a digital watch, and a quartz watch.
